(19) United States
(12) Patent Application Publication
(10) Pub. No.: US 2012/0065942 A1
(43) Pub. Date: Mar. 15, 2012

(54) METHOD OF AN ALL-SPEED PROPELER

(76) Inventors: Jeng-Lih HWANG, New Taipei City (TW); Ching-Ya Hsin, New Taipei City (TW); Shang-Sheng Chin, New Taipei City (TW)

(21) Appl. No.: 13/181,340

(22) Filed: Jul. 12, 2011

(30) Foreign Application Priority Data
Sep. 10, 2010 (TW) 099130781

(51) Int. Cl. B63B 9/00; G06F 17/50

(52) U.S. Cl. 703/1

(57) ABSTRACT

A design method of an all-speed propeller includes five steps; a first step (A) of creating a basic shape of an all-speed propeller, a second step (B) of optimization of circulation distribution, a third step (C) of adjusting the shape of the all-speed propeller, a fourth step (D) of analysis of thrust and torsion and fifth step (E) of finishing the design of the all-speed propeller. With parameters of a design request repeatedly processed by a lifting line program, a lifting surface program and a boundary element program in the steps mentioned previously, the all-speed propeller can lower cavitation effect caused by different speeds on the capacity of the propeller, so as to enable efficiency kept rather high without sharply lowering while navigating in diverse speeds.

### BACKGROUND OF THE INVENTION

1. Field of the Invention

This invention relates to a design method of marine propellers, particularly to one designing an advanced hydrofoil for all speed.

2. Description of the Prior Art

Commonly, conventional marine propellers mainly count on NACA, KCA or supercavitating series. FIG. 1 shows a NACA propeller. As shown in FIG. 2(A) to 2(D), by means of analysis of viscous flow and cavitation, if the area ratio of the propeller is 1.0, the efficiency is 0.72 when navigating at 20 knots and lowered to 0.5 when navigating up to 40 knots. Therefore, it's found that the conventional NACA propeller may lower its efficiency posed by cavitation while shifting among diverse speeds. That is, the conventional NACA propeller only can work with a best efficiency within a limited range of speed, but sharply lowering the efficiency outside the limited range.

### SUMMARY OF THE INVENTION

Nowadays, conventional NACA or KCA propellers are used to travel under 30 knots, and supercavitating propellers are used for a speed more than 30 knots. However, the speed that a ship regularly navigates with ranges from 20 knots to 40 knots. If a NACA or KCA propeller is utilized, its efficiency is to be sharply reduced owing to cavitation while navigating over 30 knots. Moreover, cavities created around the surface of the propeller due to cavitation may get broken to make the ship tremble or shake.

The object of this invention is to offer a design method of an all-speed propeller.

The designing method according to the invention includes five steps: a first step (A) of creating a basic shape of an all-speed propeller, a second step (B) of optimization of circulation distribution, a third step (C) of adjusting said shape of said all-speed propeller, a fourth step (D) of analysis of thrust and torsion and a fifth step (E) of finishing design of said all-speed propeller. If propeller thrust and torsion gained after being corrected through the steps mentioned previously consist with preset values, the design of the all-speed propeller is finished. If not, second, the third and the fourth steps (B)-(D) have to be reprocessed, with the parameters of the design request revised and re-computed by the lifting line program, the lifting surface program and the boundary element program.

The design request processed in the second step (B) to gain optimization of circulation distribution is selected from a group consisting of propeller torsion and propeller thrust.

The fourth step (D) may further revise the parameters of a design request computed by the lifting line program, the lifting surface program and the boundary element program in the second, the third and the fourth steps (B)-(D)

So, in a common range of speed that a ship regularly navigates with, the all-speed propeller of the invention can not only lower cavitation effect caused by different speeds, but also reduce breakage of cavities adsorbing on the upper pressure surface and the bottom pressure surface of each of the blades, so as to keep a rather high efficiency without sharply dropping while navigating in diverse speeds.

### BRIEF DESCRIPTION OF DRAWINGS

This invention is better understood by referring to the accompanying drawings, wherein:

FIG. 1 is a perspective view of a conventional NACA propeller;

FIG. 2(A) to 2(D) are charts of pressure distribution and cavitation of the conventional NACA propeller at 40 knots;

FIG. 3 is a flow chart of a preferred embodiment of a design method of an all-speed propeller in the present invention;

FIG. 4 is a perspective view of an all-speed propeller made by a design method in the present invention;

FIG. 5(A) to 5(D) are charts of pressure distribution and cavitation of an all-speed propeller made by the design method in the present invention;

FIG. 6 is a cavitation analysis of viscous flow of the all-speed propeller made by the design method in the present invention;

FIG. 7 is a chart comparing efficiency between the propeller of the present invention and the conventional propeller in different speeds; and

FIG. 8 is a chart of a propeller load versus efficiency, comparing the propeller of the present invention and the conventional propeller navigating at 20 knots and 40 knots.

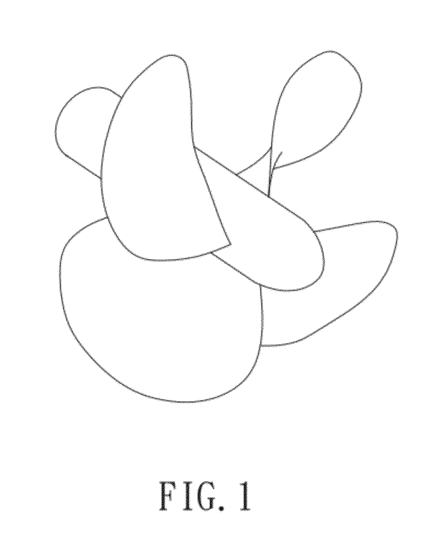

### DETAILED DESCRIPTION OF THE PREFERRED EMBODIMENT

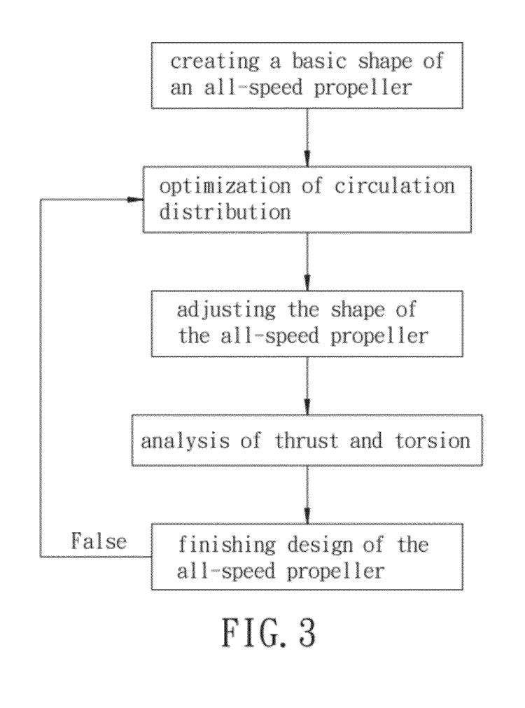

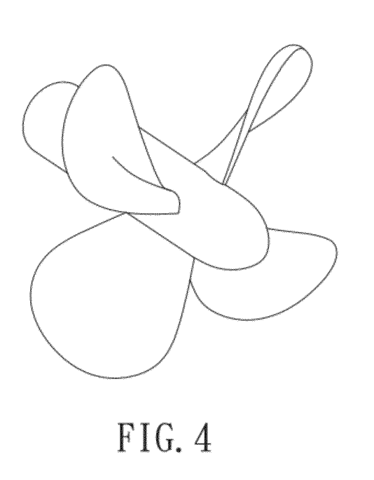

FIGS. 3 and 4 show a preferred embodiment of a design method of an all-speed propeller in the present invention. A propeller designed by this invention can work well in diverse speeds, with cavitation effect lessened to keep efficiency from dropping sharply. The design method of an all-speed propeller of the invention includes five steps described below.

A first step (A) of creating a basic shape of an all-speed propeller

The all-speed propeller is composed of plural blades, with an upper pressure surface and a bottom pressure surface for each of the blades. Environmental parameters are created according to main motor power, rotational speed, marine navigating speed and diameter of the propeller. And based on the environmental parameters, chord length ratio and expansion area ratio (EAR) of different radii selected, and basic hydrofoil sections of an all-speed propeller selected, a basic shape of an all-speed propeller can be established.

A second step (B) of optimization of circulation distribution

By keying parameters related to a design request in a lifting line program, it is to compute a load distribution for the upper pressure surface and bottom pressure surface respectively, so as to achieve an optimization of circulation distribution for the all-speed propeller. The design request is selected from a group consisting of propeller torsion and propeller thrust.

A third step (C) of adjusting the shape of the all-speed propeller

By keying parameters of the basic shape and the optimization of circulation distribution of the all-speed propeller in a lifting surface program, it is to provide an adjusted shape of the all-speed propeller, a pitch ratio and an arch chord ratio.

A fourth step (D) of analysis of thrust and torsion

The shape of the all-speed propeller adjusted by the third step (C) can be further calculated by a boundary element program. Then, combining the pitch ratio and the arch chord ratio gained in step (C) to carry out coupling design, the all-speed propeller can obtain its thrust and torsion.

A fifth step (E) of finishing design of the all-speed propeller

If the thrust and the torsion of the corrected all-speed propeller consist with the preset values, design of the present all-speed propeller is finished. If not, steps (B)-(D) have to be reprocessed, with parameters of the design request revised and re-processed in the lifting line program and the lifting surface program.

So, in a common range of speed that a ship regularly navigates with, the all-speed propeller of the invention can not only lower cavitation effect caused by different speeds, but also reduce breakage of cavities adsorbing on the upper pressure surface and the bottom pressure surface of each of the blades, so as to maintain a rather high efficiency without sharply dropping while navigating in diverse speeds.

In order to further understand the structural features, operative techniques and expected effects of the invention, how to use the invention is to be described below.

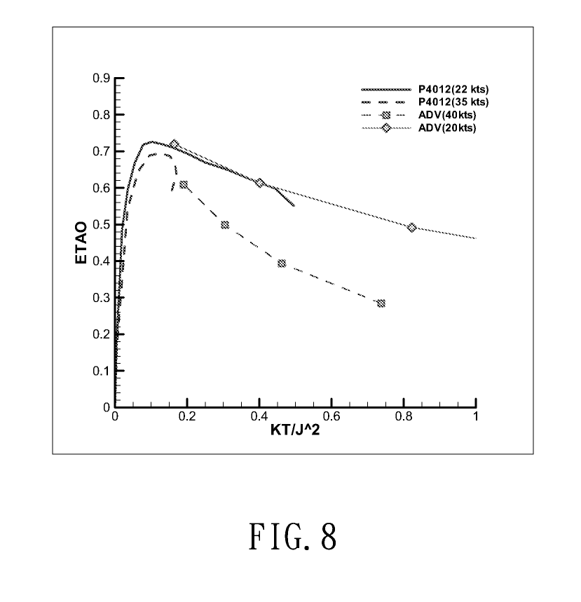

With reference to FIGS. 3 and 8, by means of inputting environmental parameters including those of main motor power, rotational speed, marine navigating speed and the diameter of the propeller as described in the first step (A), a preferred embodiment of the invention has four blades, with each blade having a diameter of 1M. An advance coefficient related to rotational speed and marine navigating speed is 1.14, and KQ coefficient is 0.0509. Applied speed ranges from 20 knots to 40 knots. The embodiment of the invention does not allow a sharp thrust drop posed by cavitation to happen, so its area can be shrunk. The area ratio is 0.667 in this embodiment. Next, according to the second step (B), parameters related to torsion and thrust requested in designing the embodiment of the all-speed propeller are keyed in the lifting line program to calculate optimization of circulation distribution. Then, computed through the lifting surface program of the third step (C), an adjusted shape of the all-speed propeller, a pitch ratio and an arch chord ratio can be obtained. Finally, analyzing the adjusted all-speed propeller by the boundary element program mentioned in the fourth step (D), the all-speed propeller can gain proper thrust and torsion. If the thrust and the torsion of the all-speed propeller consist with the preset values, design of the present all-speed propeller is finished. If not, the second, the third and the fourth steps (B)-(D) have to be reprocessed, with the parameters of the design request revised and re-computed by the lifting line program, the lifting surface program and the boundary element program.

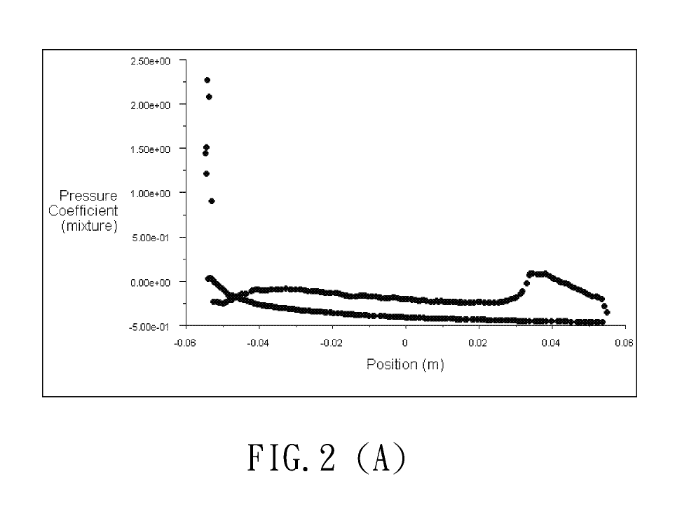

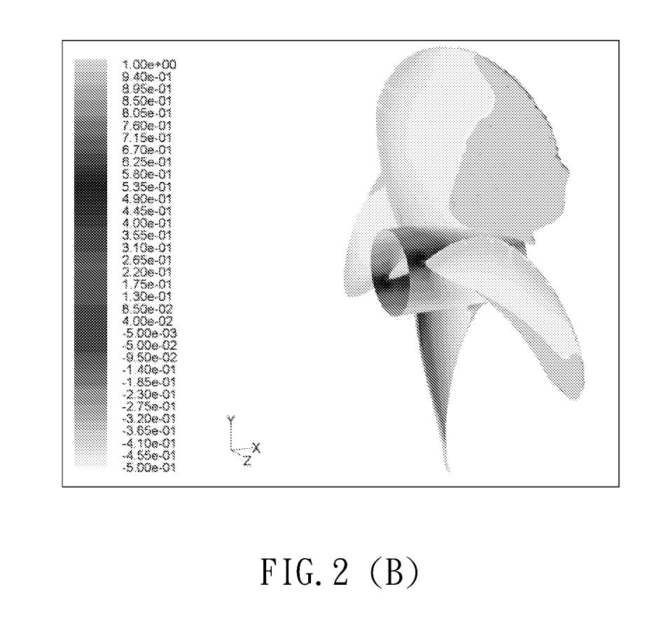

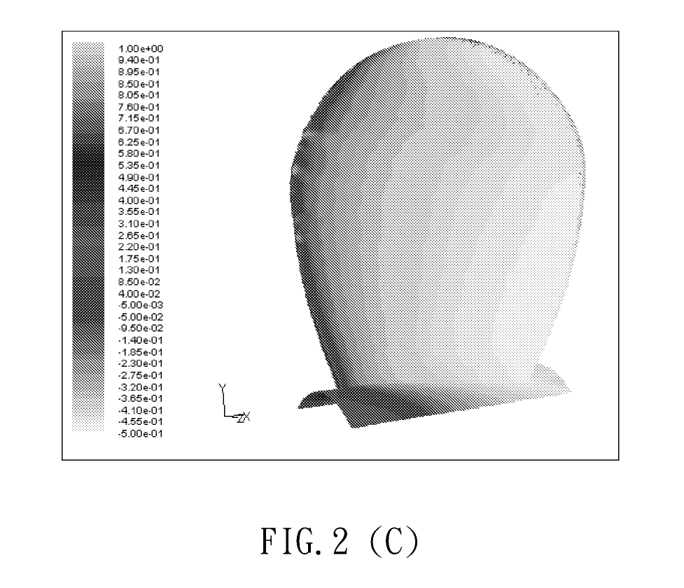

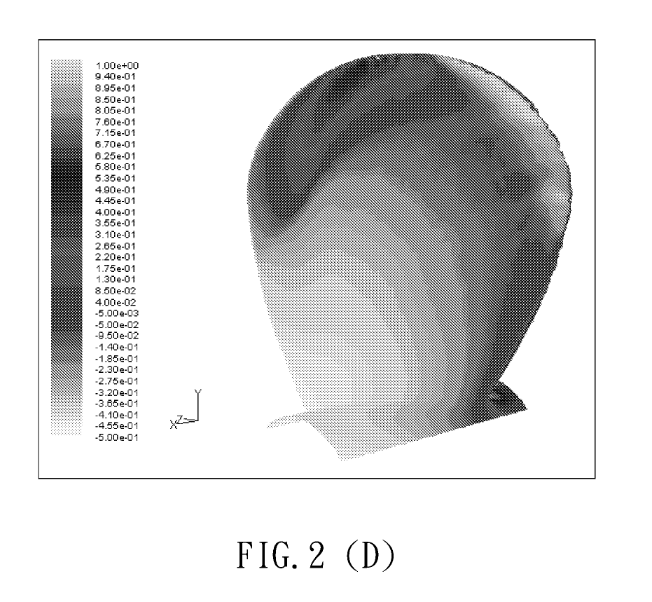

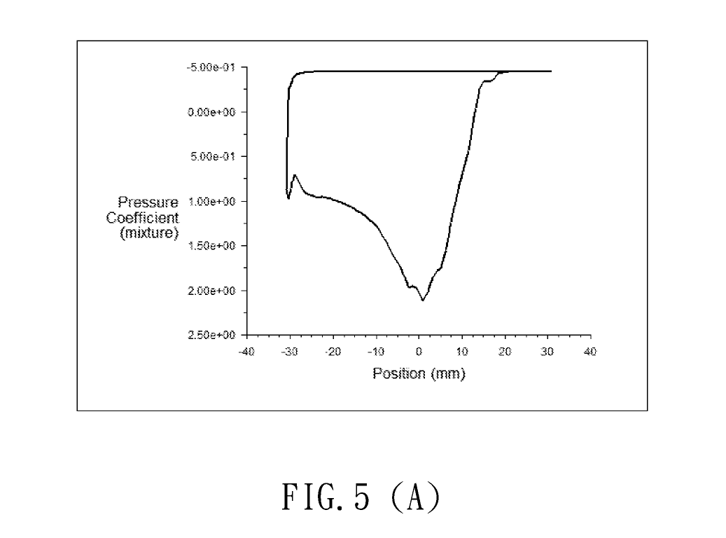

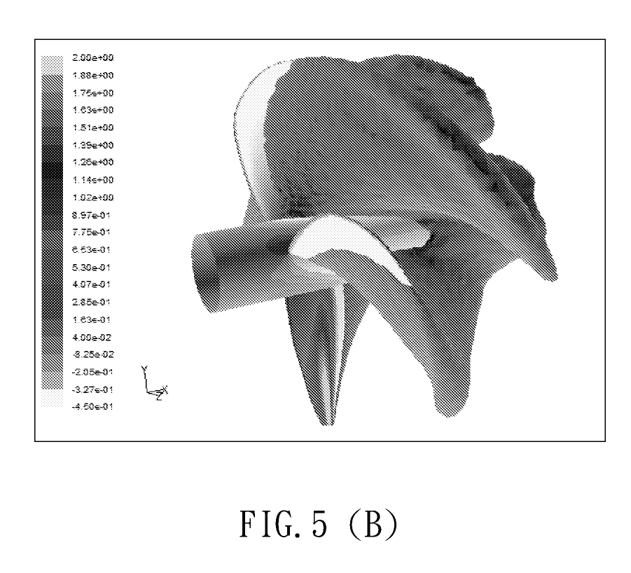

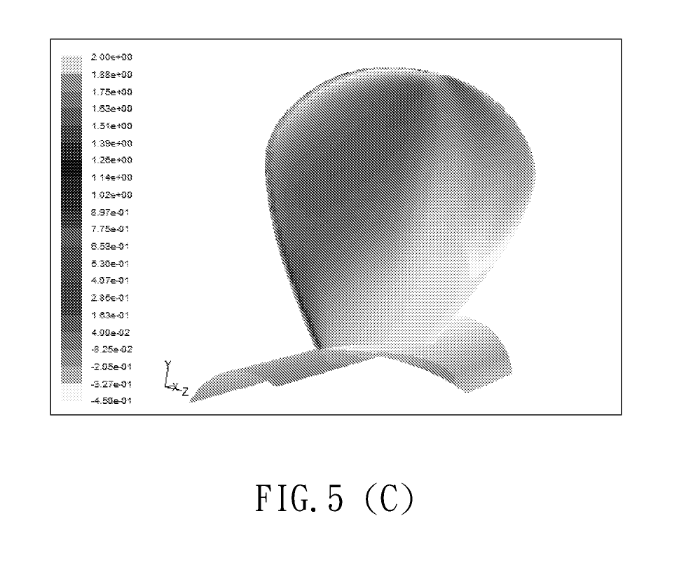

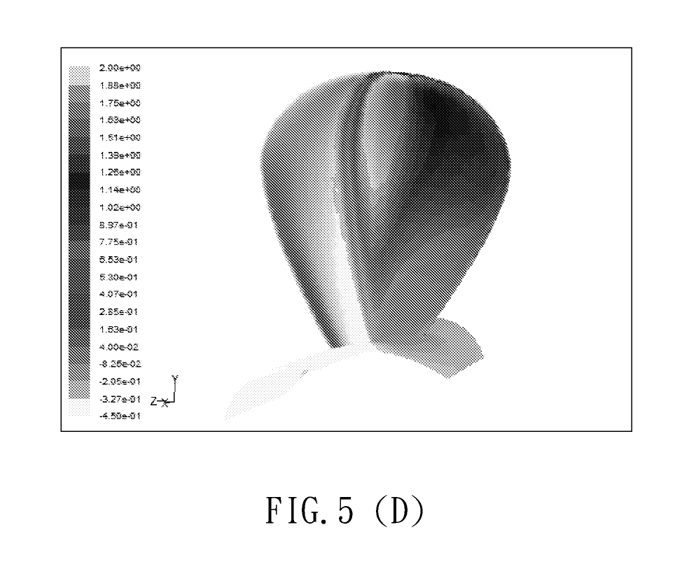

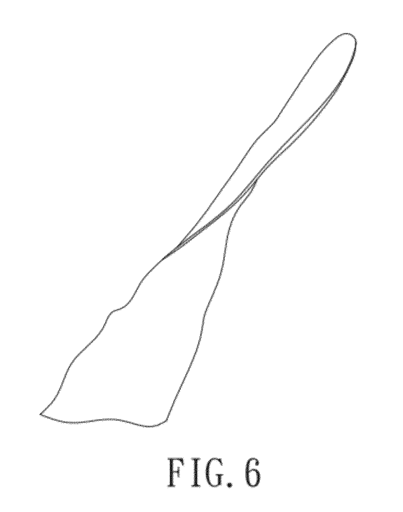

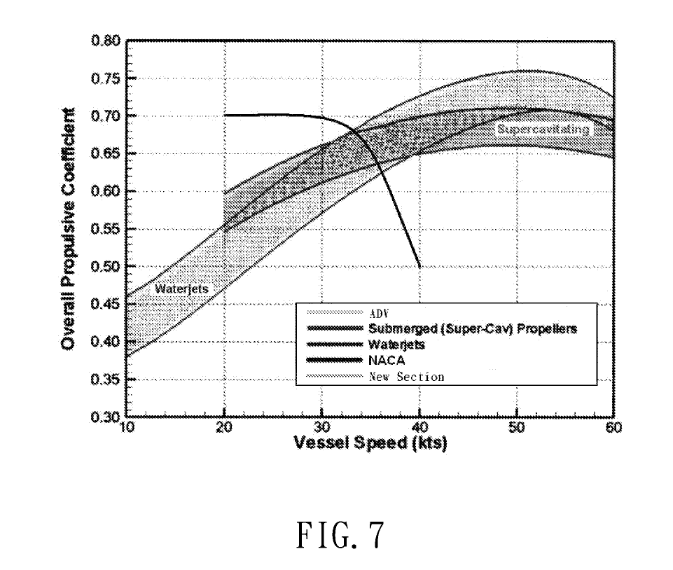

Furthermore, as shown in FIGS. 4 and 5(A) to 5(D), with regard to viscous flow analysis of cavitation module, it's found that the all-speed propeller designed according to the invention has an efficiency of 0.72 at a speed of 20 knots and 0.6 at 40 knots. Comparing FIG. 2(A) to 2(D) with the pressure distribution shown in FIG. 5(A) to 5(D), it is also found that the thrust of the all-speed propeller does not sharply drop when speed is elevated from 20 knots to 40 knots. When cavitation begins to turn up, cavities created by cavitation are to form from a guiding edge of a sucking surface without adsorbing on the surface of the blades of a propeller, creating a great resistance to lessen thrust and efficiency. In FIG. 6, according to the third and the fourth steps (C) and (D), coupling design relating to pitch ratio and arch chord ratio of the all-speed propeller is carried out, with a result that cavities create from a guiding edge of a sucking surface, but attaching on the surface of the blades of the all-speed propeller; that is, a reduction of resistance is achieved, conforming to supercavitation. And with reference to FIG. 7, it shows the embodiment of the all-speed propeller has a rather average efficiency in different speeds, without any obvious drop for its thrust and efficiency. Furthermore, FIG. 8 is a chart of a propeller load versus its efficiency, comparing the embodiment of the all-speed propeller and a conventional propeller navigating at 20 knots and 40 knots; at 20 knots, it shows that the embodiment of the all-speed propeller has an efficiency almost equivalent to that of the conventional propeller; at 40 knots, it shows that the conventional propeller drops sharply and the all-speed propeller in the invention comparatively drops much more slowly and smoothly.

The invention has the following characteristics and expected effects as can be seen from the foresaid description.

1. An all-speed propeller designed by the design method according to the present invention can conquer cavitation effect that may pose a sharp efficiency drop for a conventional propeller while regularly navigating in diverse speeds.

2. An all-speed propeller designed by the design method according to the present invention can keep a rather high efficiency without sharply dropping while regularly navigating in diverse speeds.

While the preferred embodiment of the invention has been described above, it will be recognized and understood that various modifications may be made therein and the appended claims are intended to cover all such modifications that may fall within the spirit and scope of the invention.

What is claimed is:

1. A design method of an all-speed propeller, said all-speed propeller able to lower cavitation effect on efficiency and speed of said propeller while said cavitation effect is created during a ship's navigating in diverse speeds, said design method comprising:
a first step (A) of creating a basic shape of an all-speed propeller, said all-speed propeller composed of plural blades, each said blade provided with an upper pressure surface and a bottom pressure surface, plural environmental parameters created according to power of a main body and a rotational speed and a marine navigating speed and a diameter of said propeller, a basic shape of said all-speed propeller being established by counting on said environmental parameters and a chord length ratio and an expansion area ratio of different radii selected and basic hydrofoil sections of said all-speed propeller;
a second step (B) of optimization of circulation distribution, keying parameters related to a design request in a lifting line program to compute a pressure load distribution for said upper pressure surface and said bottom pressure surface respectively so as to achieve an optimization of circulation distribution;
a third step (C) of adjusting said shape of said all-speed propeller, keying parameters of said basic shape and said optimization of circulation distribution of said all-speed propeller in a lifting surface program to obtain an adjusted shape of said all-speed propeller and a pitch ratio and an arch chord ratio;
a fourth step (D) of analysis of thrust and torsion, said adjusted shape of said all-speed propeller corrected by said third step (C) further calculated by boundary element program and then combined with said pitch ratio and said arch chord ratio gained in said third step (C) to carry out a coupling design so as to obtain its thrust and torsion.
a fifth step (E) of finishing design of said all-speed propeller, a design being completed if said thrust and torsion of said corrected all-speed propeller consist with preset values, reprocessing said second, said third and said fourth steps (B)-(D) if not; and
said all-speed propeller able to lower cavitation effect caused by different speeds that a ship regularly navigates and reduce breakage of cavities adsorbing on said upper pressure surface and said bottom pressure surface of each of said blades so as to keep a rather high efficiency without sharply lowering while navigating in diverse speeds.

2. The design method of an all-speed propeller as claimed in claim 1, wherein said design request needed for said optimization of circulation distribution in said second step (B) is selected from a group consisting of a propeller torsion and a propeller thrust.

3. The design method of an all-speed propeller as claimed in claim 1, wherein said fifth step (E) has further revised said parameters of a design request computed by said lifting line program, said lifting surface program and said boundary element program in said second, said third and said fourth steps (B)-(D).
